(19) United States
(12) Patent Application Publication
(10) Pub. No.: US 2026/0070107 A1
(43) Pub. Date: Mar. 12, 2026

(54) HOT ROLLING WITH RESIDUAL ELEMENTS

(71) Applicant: ArcelorMittal, Luxembourg (LU)

(72) Inventors: Thierry IUNG, Jarny (FR); Ronan JACOLOT, Landonvillers (FR)

(21) Appl. No.: 19/108,872

(22) PCT Filed: Sep. 15, 2023
(86) PCT No.: PCT/IB2023/059177

§ 371 Date: Mar. 5, 2025

(30) Foreign Application Priority Data
Sep. 15, 2022 (WO) PCT/IB2022/058708

(51) Int. Cl. B21B 3/02; B21B 1/22; B21B 1/26

(52) U.S. Cl. CPC B21B 3/02; B21B 1/26; B21B 2001/225

(57) ABSTRACT

A method for hot rolling a steel including the steps of i. elaborating, by smelting steel scrap including at least one of the following residual elements: Mo, Sn, Sb, As, a steel grade having a theoretical hot rolling temperature T_{HR_TH}, by smelting steel scraps including at least one of the following residual elements: Mo, Sn, Sb, As, and optionally hot metal coming from a blast furnace and/or direct reduced iron, ii. estimating the liquid steel composition, iii. casting a semi-finished product with the liquid steel, iv. defining, T_{OFFSET}, the smallest hot rolling temperature increase able to offset the presence of the residual elements: Mo, Sn, Sb and/or As, v. hot rolling the semi-finished product at a temperature T_{HR} being: T_{HR}=T_{HR_TH}+T_{OFFSET}.

This invention relates to a method for hot rolling a semi-finished steel product comprising residual elements resulting from the steel elaboration using steel scraps.

### BACKGROUND

Steelmaking requires the use of iron-containing material, such as steel scraps, direct reduced iron or pig iron. In order to reduce the carbon footprint of the steel industry, the use of steel scraps is seen as key. However, steel scraps contain residual elements, such as copper, chromium, molybdenum, nickel, tin, antimony, zinc and/or arsenic. The use of steel scraps is therefore not widely spread for all steel grades as those residual elements can have a detrimental effect on the steel properties.

### SUMMARY OF THE INVENTION

During the steel elaboration by means of direct reduced iron and/or pig iron, small amounts of residual elements are inevitably left behind in the liquid steel. When using steel scraps, the amount of residual elements is much greater compared to pig iron coming from a blast furnace or direct reduced iron.

It has been recently observed by the present inventors that the production of steel using significant amount of steel scraps is raising issues during some manufacturing steps like hot rolling for example.

A goal of this invention is therefore to increase the hot rolling processability of a semi-finished steel product made, at least partly, from steel scraps.

The present invention provides a method for hot rolling a steel semi-finished product comprising the steps of:
i. elaborating a steel composition comprising in weight percent: 0.002≤C≤0.8, 0.1≤Mn≤3, Si≤2, Al≤2, Cr≤0.5, Nb≤0.08, Ti≤0.1 and a balance consisting of Fe, residual elements consisting of Mo, Sn, Sb and As and unavoidable impurities, by smelting steel scraps comprising at least one of said residual elements and optionally hot metal coming from a blast furnace and/or direct reduced iron,
ii. estimating the liquid steel composition,
iii. casting a semi-finished product with said liquid steel, having a theoretical finishing hot rolling temperature T_{HR_TH},
iv. defining, T_{OFFSET}, a hot rolling temperature increase able to offset the presence of said residual elements: Mo, Sn, Sb and/or As, on the mean flow stress resulting from the deformation applied during the hot rolling, wherein

$${T}_{OFFSET} = a \times [ Mo ] \times {( \frac{{T}_{{HR}_{TH}}}{1000} )}^{α} + b \times [ Sn ] \times {( \frac{{T}_{HR \_ TH}}{1000} )}^{β} + c \times [ Sb ] \times {( \frac{{T}_{HR \_ TH}}{1000} )}^{γ} + d \times [ As ] {( \frac{{T}_{HR \_ TH}}{1000} )}^{δ}$$

wherein [Mo] is the weight percent of Molybdenum, [Sn] is the weight percent of tin, [Sb] is the weight percent of antimony and [As] is the weight percent of arsenic, and wherein a, b, c and d are coefficients representing the impact of respectively molybdenum, tin, antimony and arsenic on the mean flow stress resulting from the deformation applied during the hot rolling and
wherein α, β, γ and δ are coefficients representing temperature dependency of the impact of molybdenum, tin, antimony and arsenic on the mean flow stress resulting from the deformation applied during the hot rolling,
v. hot rolling said semi-finished product at an optimised hot rolling temperature T_{HR} being:

$${T}_{HR} = {T}_{HR \_ TH} + {T}_{OFFSET} .$$

### DETAILED DESCRIPTION

The elaboration of the steel grade, in step i., can be done using any means such as for example a basic oxygen furnace, an open-hearth furnace and/or an electric arc furnace.

The material charged is made of steel scraps and optionally hot metal coming from a blast furnace and/or direct reduced iron. For example, the steel scraps that can be used are referred to, in the EU-21 Steel Scrap specification, as old scraps (E1 or E3), new scraps (E8), shredded scraps (E40) or fragmentized scraps (E46).

Preferably, in step i., from 100 to 1000 kg of steel scraps per ton of hot metal are used. Preferably, in step i., from 100 to 950 kg of steel scraps per ton of hot metal are used. Preferably, in step i., from 100 to 900 kg of steel scraps per ton of hot metal are used. Preferably, in step i., from 100 to 800 kg of steel scraps per ton of hot metal are used. Preferably, in step i., from 100 to 600 kg of steel scraps per ton of hot metal are used. Preferably, in step i., from 100 to 500 kg of steel scraps per ton of hot metal are used. Even more preferably, in step i., from 200 to 400 kg of steel scraps per ton of hot metal are used.

In the present disclosure, the residual elements are the non-desired elements coming from the steel scrap. The unavoidable impurities come from the elaboration process, e.g. oxides, nitride.

Preferably, the steel composition comprises from 0.01 weight percent to 0.5 weight percent of residual elements. Even more preferably, the steel composition comprises from 0.05 weight percent to 0.30 weight percent of residual elements.

Preferably, in said elaboration step i. said steel scraps comprises at least two of said residual elements. Even more preferably, in said elaboration step i. said steel scraps comprises at least two of said residual elements with a weight percent each from 0.02 to 0.30 weight percent.

Preferably, the step i., comprises a refining step. This refining step includes a desulfurization step and/or a dephosphorization step. This refining step is preferably done in a ladle furnace.

The steel composition of the liquid steel can be estimated at the end of the elaboration step and/or at the beginning of the casting step. Preferably, such estimation is performed at the beginning of the casting of the semi-finished product. The estimation of the steel composition is preferably performed by analysing lollipop samples from the hot metal ladle that is used to fill in the casting tundish or the ingot mould to obtain the semi-finished product.

The casting can be any type of casting process. The casting is preferably a continuous casting. The semi-finished product can be for example a billet, a bloom, a blank, a slab, a bar or an ingot. Such semi-finished products are then reheated and hot rolled to reduce their thickness to a target depending on their future use.

Preferably, between the casting step iii. and the step iv., a rolling pattern is defined.

In order to hot roll a casted semi-finished product, the person skilled in the art establishes a rolling pattern. As well known by the person skilled in the art, establishing the rolling pattern requires information on the steel such as the stress-strain curve, the composition and the initial microstructure of the steel to be hot rolled. The rolling pattern includes, among other parameters, the reduction rate, the strain rate and the hot rolling temperature for each hot rolling stand (e.g.; for each rolling pass) respecting mass flow equation.

Then, based on the steel information and the rolling pattern, it is possible to define a mean flow stress to apply at each rolling stand. The mean flow stress is equal to the area under the stress-strain curve from a strain ε_{α} to a strain ε_{β}.

Then, using the mean flow stress to apply at each pass, the person skilled in the art is able to properly configure the rolling stands and define pre-set for each hot rolling.

However, in the state of the art, the content of residual elements from steel scrap is not taken into account when establishing the rolling pattern. Therefore, the theoretical stress-strain curve is defined without taking into consideration said residual elements.

Moreover, it has surprisingly been found that the presence of specific residual elements coming from the steel scraps, namely Mo, Sn, Sb and As, leads to a deviation from the theoretical stress-strain curve. This deviation leads to a change of the mean flow stress allowing to achieve the targeted strain rate.

At each stand, a stress is applied on the semi-finished steel product by a pair of cylinder rolls. Each hot rolling stand has a maximum stress it can apply.

Consequently, all other parameters being equal, when applying a targeted reduction rate during the hot rolling of a steel elaborated from steel scrap containing said residual elements, the mean flow stress applied deviates from the theoretical mean flow stress to achieve the targeted strain rate.

This deviation can lead to processability issue and possibly to an accelerated degradation of the rolling cylinder because the expected stress applied by the hot rolling stand is smaller than the real one applied.

In order to counter this surprising effect of the residual elements, the inventors proposed to increase the hot rolling temperature defined in the rolling pattern for a steel not comprising said residual elements, i.e. the theoretical finishing hot rolling temperature T_{HR_TH}. This is done by defining a hot rolling temperature increase, T_{OFFSET}, able to offset the presence of said residual elements: Mo, Sn, Sb and/or As on the mean flow stress resulting from the deformation applied during the hot rolling.

Consequently, according to the invention, the semi-finished product is hot rolled at a temperature T_{HR} being:

$${T}_{HR} = {T}_{HR \_ TH} + {T}_{OFFSET} .$$

This newly defined hot rolling temperature allows to achieve the targeted reduction rate when applying the mean flow stress defined by the rolling pattern.

As known per the person skilled in the art, to achieve a temperature at any rolling stand, e.g. in the active hot rolling stand, it is possible to act on several parameters.

For example, hot strip mills generally comprise a reheating step before the rolling step. Based on the required minimum hot rolling temperature at a rolling stand, e.g. the last hot rolling stand, it is possible to determine the required temperature at the end of the reheating step.

Alternatively, when the hot rolling is done after the casting, as it is for some compact strip production mill, it is possible to influence the rolling temperature by varying the speed of the strip.

Moreover, it is possible to use heating systems placed between the stands and/or between the roughing mill and the hot rolling mill. Furthermore, it is possible to use a heat cover to influence the temperature at the hot rolling stand.

Generally, devices able to measure the steel semi-products, such as pyrometers, are placed between the roughing mill, the hot rolling mill and after the last hot rolling stand of the rolling mill.

The hot rolling can be performed by any means able to hot roll a semi-finished steel product. Preferably, the hot rolling step is performed by a hot rolling mill comprising from three to eight rolling stands and even more preferably from five to seven rolling stands. Preferably, the hot rolling step is performed by a reversible rolling stand.

The theoretical finishing hot rolling temperature can be a single temperature value or can be a range of temperature. For example, if the theoretical finishing hot rolling temperature is a range of temperature being from T_{HR_TH-MIN} and T_{HR_TH-MAX}, the semi-finished product is hot rolled at a temperature THR being T_{HR_TH-MIN}+T_{OFFSET}≤T_{HR}≤T_{HR_TH-MAX}+T_{OFFSET}.

The determination of the theoretical finishing hot rolling temperature is a step well known by the person skilled in the art. This determination can take into consideration metallurgical constraints, to achieve desired properties, and format consideration. For example, it can be done be using the Sims model coupled to the Misaka model as explained in the section “III. Methodology A. Mechanical approaches” of R. Hwang, H. Jo, K. S. Kim and H. J. Hwang, “Hybrid Model of Mathematical and Neural Network Formulations for Rolling Force and Temperature Prediction in Hot Rolling Processes,” in IEEE Access, vol. 8, pp. 153123-153133, 2020.

Preferably, [Mo]/0.12+[Sn]/0.04+[Sb]/0.015+[As]/0.03≥1. Modification of the hot rolling process then occurs only above a residual element content threshold.

Preferably, the method comprises the establishment of a rolling pattern comprising a theoretical finishing hot rolling temperature for each hot rolling pass. Even more preferably, said rolling pattern also comprises a strain rate for each rolling pass.

Preferably, said establishment of said rolling pattern, is done in step iv. Even more preferably, said establishment of said rolling pattern, is done before the definition of T_{OFFSET}.

T_{OFFSET} can be defined using the models from Sellars and Tegart. Details on the model from Sellars and Tegart can be found in ““J. J. Jonas, C. M. Sellars, W. J. M. Tegart, Strength and structure under hot-working conditions, Metall. Rev. 14 (1) (1969) 1-24.” and “Changmin Li, Liang Huang, Mingjie Zhao, Xiaoting Zhang, Jianjun Li, Pengchuan Li, Influence of hot deformation on dynamic recrystallization behavior of 300M steel: Rules and modeling, Materials Science and Engineering: A, Volume 797, 2020, 139925, ISSN 0921-5093”.

A formula defining T_{OFFSET} for various composition can be defined using calculated values of T_{HR} and T_{OFFSET} and a statistical model to find the right coefficients.

Even more preferably, in the equation defining T_{OFFSET}, a=92, b=264, c=639, d=326 and α=0, β=0.164, γ=−1.64 and δ═−2.43.

Preferably, said T_{OFFSET} is defined for the last active rolling stand.

The following section deals with simulations showing the impact of the present invention.

In each simulation, a steel having the following composition: 0.1 weight percent of C, 1 weight percent of Mn, 0.2 weight percent of Si, 0.009 weight percent of P, 0.02 weight percent of Al and 0.007 weight percent of N, and varying amounts of residual elements is studied.

This set of examples focus on the last rolling stand. In those examples, the rolling pattern defines a strain rate and a hot rolling temperature for the last rolling stand.

Then, the theoretical mean flow stress at the theoretical finishing hot rolling temperature is calculated. The theoretical mean flow stress is the one where said residual elements are not taken into account. The real mean flow stress, taking into account the residual elements at the theoretical finishing hot rolling temperature is also calculated to show the influence of the residual elements.

Then, the hot rolling temperature increase T_{OFFSET} is defined using the following equation:

$${T}_{OFFSET} = 92 * [ Mo \% ] + 240 * [ Sn \% ] * {( \frac{{T}_{{wo}_{res}}}{1000} )}^{0.164} + 639 * [ Sb \% ] * {( \frac{{T}_{{wo}_{res}}}{1000} )}^{- 1.64} + 326 * [ As \% ] * {( \frac{{T}_{{wo}_{res}}}{1000} )}^{- 2.43}$$

wherein [Mo] is the weight percent of Molybdenum, [Sn] is the weight percent of tin, [Sb] is the weight percent of antimony and [As] is the weight percent of arsenic.

Then, the optimised hot rolling temperature for each example is calculated using the following equation:

$${T}_{HR} = {T}_{HR \_ TH} + {T}_{OFFSET} ,$$

wherein T_{HR} is the optimised hot rolling temperature, T_{OFFSET} is the hot rolling temperature increase and T_{HR_TH} is the theoretical finishing hot rolling temperature.

One can observe that the real mean flow stress at the optimised hot rolling temperature, when the residual elements are taken into account, is the same as the theoretical mean flow stress at the theoretical finishing hot rolling temperature, when the residual elements are not taken into account.

TABLE 1

| | | | |
|---|---|---|---|
| Steel A | Steel B | Steel C | Steel D |

Content of residual elements

| | | | | |
|---|---|---|---|---|
| Mo [weight percent] | 0.15 | 0 | 0.10 | 0.10 |
| Sn [weight percent] | 0.08 | 0.10 | 0 | 0.05 |
| Sb [weight percent] | 0 | 0 | 0.05 | 0.05 |
| As [weight percent] | 0 | 0.05 | 0 | 0.05 |

Rolling parameters

| | | | | |
|---|---|---|---|---|
| Strain rate | 100 | 100 | 100 | 100 |
| Thickness before the last | 3.2 | 3.2 | 3.2 | 3.2 |
| hot rolling stand | | | | |
| Thickness at after the last | 2.8 | 2.8 | 2.8 | 2.8 |
| hot rolling stand | | | | |

Theoretical value

| | | | | |
|---|---|---|---|---|
| Theoretical finishing hot rolling | 900 | 950 | 1000 | 950 |
| temperature T_{HR}_{_{—}}_{TH} [° C.] | | | | |
| Theoretical Mean flow stress | 135 | 122 | 111 | 122 |
| at T_{HR}_{_{—}}_{TH} [MPa] | | | | |
| Real Mean flow stress | 143 | 132 | 122 | 145 |
| at T_{HR}_{_{—}}_{TH} [MPa] | | | | |

Optimised value

| | | | | |
|---|---|---|---|---|
| Hot temperature increase T_{OFFSET} | 36 | 32 | 31 | 46 |
| Optimised hot rolling | 936 | 982 | 1027 | 999 |
| temperature [° C.] | | | | |
| Real Mean flow stress | 135 | 122 | 111 | 122 |
| at T_{HR} [MPa] | | | | |

What is claimed is:

1-5. (canceled)

6. A method for hot rolling a steel comprising the following steps:
i. elaborating a steel composition comprising in weight percent:
$$0.002 \leq C \leq 0.8 ;$$
$$0.1 \leq Mn \leq 3 ;$$
$$Si \leq 2 ;$$
$$Al \leq 2 ;$$
$$Cr \leq 0.5 ;$$
$$Nb \leq 0.08 ;$$
$$Ti \leq 0.1 ; and$$
a balance of Fe, residual elements of Mo, Sn, Sb and As, and unavoidable impurities, by smelting steel scraps comprising at least one of the residual elements and optionally hot metal coming from a blast furnace or direct reduced iron, so as to form a liquid steel with a liquid steel composition;
ii. estimating the liquid steel composition;
iii. casting a semi-finished product with the liquid steel, having a theoretical finishing hot rolling temperature T_{HR_TH};
iv. defining, T_{OFFSET}, a finishing hot rolling temperature increase able to offset a presence of the residual elements: Mo, Sn, Sb and As, on the mean flow stress resulting from the deformation applied during the hot rolling, wherein
$${T}_{OFFSET} = a \times [ Mo ] \times {( \frac{{T}_{{HR}_{TH}}}{1000} )}^{α} + b \times [ Sn ] \times {( \frac{{T}_{HR \_ TH}}{1000} )}^{β} + c \times [ Sb ] \times {( \frac{{T}_{HR \_ TH}}{1000} )}^{γ} + d \times [ As ] {( \frac{{T}_{HR \_ TH}}{1000} )}^{δ}$$
wherein [Mo] is the weight percent of Molybdenum, [Sn] is the weight percent of tin, [Sb] is the weight percent of antimony and [As] is the weight percent of arsenic,
wherein a, b, c and d are coefficients representing the impact of respectively molybdenum, tin, antimony and arsenic on the mean flow stress resulting from the deformation applied during the hot rolling, and
wherein α, β, γ and δ are coefficients representing temperature dependency of the impact of molybdenum, tin, antimony and arsenic on the mean flow stress resulting from the deformation applied during the hot rolling; and
v. hot rolling the semi-finished product at an optimised hot rolling temperature T_{HR} being:
$${T}_{HR} = {T}_{HR \_ TH} + {T}_{OFFSET} .$$

7. The method according to claim 6 wherein the elaborating step is performed using an electric arc furnace.

8. The method according to claim 7 wherein the elaborating step includes a dephosphorization step or a desulfurization step.

9. The method according to claim 6 wherein:
$$[ Mo ] / 0.12 + [ Sn ] / 0.04 + [ Sb ] / 0.015 + [ As ] / 0.03 \geq 1 .$$

10. The method according to claim 6 wherein a=92, b=240, c=639, d=329 and α=0, β=0.164, γ=−1.64 and δ=−2.43.
